(19) United States
(12) Patent Application Publication
(10) Pub. No.: US 2010/0208130 A1
(43) Pub. Date: Aug. 19, 2010

(54) PAN AND TILT CONTROL SYSTEM WITH INDUCTIVE POWER SUPPLY

(76) Inventor: ALEXANDER P. DESORBO, Woodbury, CT (US)

Correspondence Address: MCCORMICK, PAULDING & HUBER LLP, CITY PLACE II, 185 ASYLUM STREET, HARTFORD, CT, 06103, US

(21) Appl. No.: 12/708,946

(22) Filed: Feb. 19, 2010

Related U.S. Application Data
(60) Provisional application No. 61/153,680, filed on Feb. 19, 2009.

(51) Int. Cl. H04N 5/225

(52) U.S. Cl. 348/372; 348/373; 348/E05.024

(57) ABSTRACT

A pan and tilt control system that includes a pan and tilt head having an attachment mechanism for selective attachment of an image capture device. The system further includes an inductive coupling device in electrical communication with the pan and tilt head. The coupling device is rotatably secured to the head. The system allows an image capture device attached to the pan and tilt head to be in electrical communication with said inductive coupling device and also be rotated about a first axis in a substantially horizontal plane and about a second axis in a substantially vertical plane.

### CROSS REFERENCE TO RELATED APPLICATIONS

This application claims the benefit of U.S. Provisional Patent Application No. 61/153,680 filed on Feb. 19, 2009, which is hereby incorporated by reference in its entirety.

### FIELD OF THE INVENTION

This invention relates, in general, to a pan-and-tilt control system and deals more particularly with a method and apparatus for providing increased functional operability to image capturing, recording and/or displaying devices, or other electronic systems, via the use of an inductive power supply.

### BACKGROUND OF THE INVENTION

Modern cameras and associated image capturing, recording and/or displaying devices have become virtually ubiquitous in both residential and commercial environments. As emerging technologies make the recording of high quality still images and video easier for both the professional and amateur alike, attention has focused on improving the ease of use of such image capturing, recording and/or displaying devices.

One long-known manner in which the quality of the resultant image can be effectively increased is through the application and use of a pan and tilt head. As is known, a pan and tilt head, typically itself mounted atop a tripod, pedestal or other camera support, can be utilized in video, film or still camera photography. When so utilized, the pan (a primarily horizontal camera movement) and tilt (a primarily vertical camera movement) head functions to provide steady, continuous camera movements in two axes. A pan and tilt head may also be used to adjustably change the static orientation of numerous electronic systems such as displays, teleprompters, lighting fixtures and the like.

When affixed to such a pan and tilt head (“pan head”), electrical power and input/output data signals (such as audio, video and control signals) are connected between to the camera and/or peripheral devices attached to the camera and the power sources or other peripherals sending (or receiving) data and power. The resultant management of the cables through which these electrical signals flow to and from a camera mounted atop a tripod/head and its peripherals and power sources restricts the continuous and uninterrupted movement of the camera through its full potential range, especially in the horizontal axis.

Additionally, this necessary cabling restricts the portability of the camera when it is desired to remove it from the pan head, often due to the bundling of cables through and along the tripod or other support upon which the pan head is mounted until the cabling reaches the ground. In other applications such as surveillance, such cabling can restrict both the movement and the covert management of the camera.

Thus, the application of power, especially but not limited to mains power, and the sending and receiving of any variety of data to or from a camera requires the use of cables which restricts camera movement thereby inconveniencing the operator.

Attempts have been made to provide power (and/or data) transfer through the camera support, and pan head, without the limitations noted above. However these attempts have been made largely through the use of slip rings or similar mechanical constructs, which are prone to wear, environmental contamination and interruption. Wireless or RF signal transfer is also a solution but has other attendant obstacles and costs associated.

With the forgoing problems and concerns in mind, it is the general object of the present invention to provide a method and apparatus for providing increased power capability and functional operability to image capture and recording apparatuses via the use of an inductive power supply. In particular, it is the general object of the present invention to provide an inductive power supply as integrated into a panning camera support apparatus thereby providing necessary power to the image capture and recording apparatus without the restrictions inherent in wired camera systems.

### SUMMARY OF THE INVENTION

It is an object of the present invention to provide to a camera system and power supply for image capture and recording devices.

It is another object of the present invention to provide a method and apparatus for providing improved functional operability to image capture and recording devices by reducing or eliminating electrical cabling that impedes the operation of a camera mounted to a motion control head via the use of an inductive power supply.

It is another object of the present invention to provide a pan and tilt head assembly with inductive power supply components, for the transfer of both data and power.

An embodiment of the invention is a pan and tilt control system that includes a pan and tilt head having an attachment mechanism for selective attachment of an image capture device. The system further includes an inductive coupling device in electrical communication with the pan and tilt head. The coupling device is rotatably secured to the head. The system allows an image capture device attached to the pan and tilt head to be in electrical communication with said inductive coupling device and also be rotated about a first axis in a substantially horizontal plane and about a second axis in a substantially vertical plane.

Another embodiment of the invention is an inductive coupling device that includes a lower inductive coil portion operatively connected to a power source. The device further includes an upper inductive coil portion in electrical communication with the lower inductive coil portion. The upper portion being rotatable relative to the lower inductive coil portion about a first axis. The device also includes an attachment mechanism secured to the upper inductive coil portion, which is adapted for the attachment of an electronic device to the inductive coupling device. The upper inductive coil portion may be rotated about the first axis to change an orientation of an attached electronic device.

These and other objectives of the present invention, and their preferred embodiments, shall become clear by consideration of the specification, claims and drawings taken as a whole.

### BRIEF DESCRIPTION OF THE DRAWINGS

FIG. 1 illustrates a pan and tilt head assembly, according to one embodiment of the present invention.

FIG. 2 illustrates a matching pair of inductive coils, as integrated into the pan and tilt head assembly of FIG. 1.

FIG. 3 is a flow chart depicting a method of powering an image capture device on a pan and tilt head according to an embodiment of the present invention.

### DETAILED DESCRIPTION OF THE PREFERRED EMBODIMENT

Known image capture and recording devices, both the hand-held variety and the larger, professional devices, are known to mount by various and well known pan and tilt heads (hereinafter, “pan heads”) to provide means for stable movement of a camera while tracking a subject.

While reference has been made to pan heads, it will be readily appreciated that pan heads are frequently mounted atop tripod assemblies, or the like, and that the present invention is equally applicable to both fixedly mounted pan heads (such as those used in video surveillance), as well as support assemblies (such as tripods, stands or pedestals) having integrated pan heads. Indeed, although the present invention will be described in connection with pan head assemblies in its preferred embodiment, it will be readily appreciated that the present invention encompasses any structural assembly that is utilized to hold and/or translate an electronic image capturing, recording and/or displaying device about one or more axes.

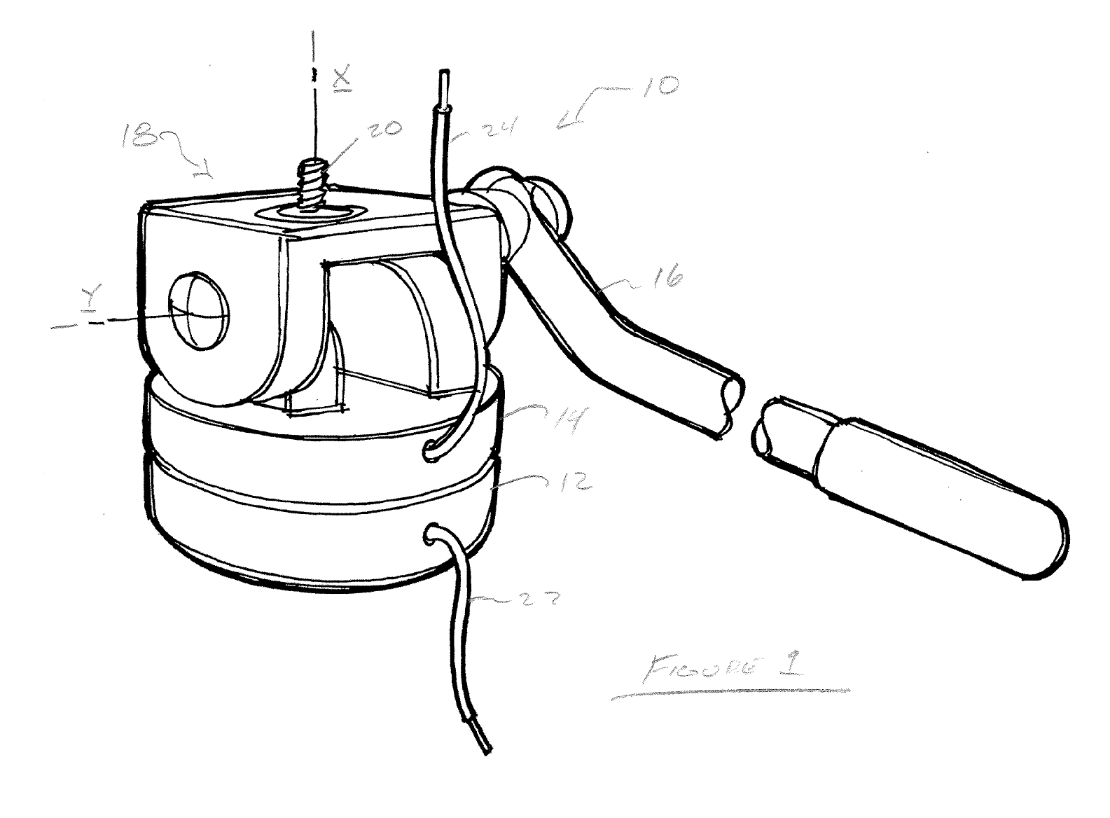

Turning to FIG. 1, a pan head assembly 10 is shown, according to one embodiment of the present invention. As can be seen in FIG. 1, the pan head assembly 10 includes both an upper or first portion 12 and a lower or second portion 14. The upper and lower portions, 12 and 14, are designed to sit in registration with one another in a manner and configuration commonly known in the art. As will be appreciated, the lower portion 14 may be removably secured to a support structure such as a tripod or similar apparatus.

The pan head assembly 10 may also include a control arm 16, for selectively controlling the translation of a mounting platform 18 about two axes, X and Y however it is understood that the present invention would apply to motorized pan mechanisms as well as those manually operated. Also illustrated in FIG. 1 is a threaded engagement member 20, which provides one known attachment means for mounting an image capture and recording device. Thus, by operation of the control handle 16, any image capture and recording device mounted thereon can be translated in at least two planes, vertical and horizontal, about axes X and Y.

Electrical connections, 22 and 24, are provided to the lower and upper portions, 12 and 14, respectively, for the transmission of electrical signals, power or data, as will be discussed in more detail later.

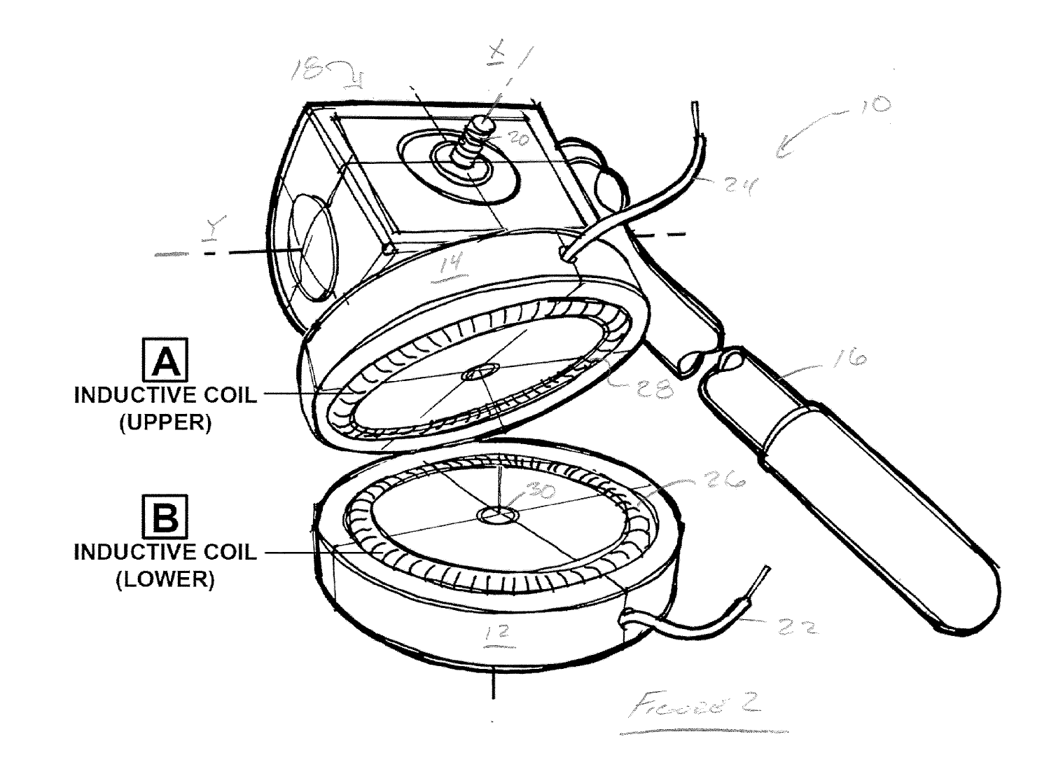

While the pan head assembly 10 of FIG. 1 may look outwardly akin to known pan head assemblies, FIG. 2 illustrates an integrated inductive power supply, in accordance with one embodiment of the present invention. As shown in FIG. 2, the lower portion 12 includes an integrated lower (primary) inductive coil 26, while the upper portion 14 includes an integrated, and matching, upper (secondary) inductive coil 28.

As will be appreciated, when the lower inductive coil 26 is energized by an appropriate AC/DC power supply via the electrical connection 22, the magnetic field created thereby will induce a similar electrical current in the upper inductive coil 28. The electrical current induced in the upper inductive coil 28 may thereafter be directly transferred to an image capture and recording device affixed to the mounting platform 18 via the electrical connection 24. In the alternative, the electrical current induced in the upper inductive coil 28 may instead be transferred by appropriate means to a rechargeable battery.

While FIG. 2 illustrates a single pair of matching inductive coils, 26 and 28, the present invention is not so limited in this regard as, alternatively, a plurality of matching pairs of inductive coils may be integrated into the upper and lower portions, 12 and 14, without departing from the broader aspects of the present invention. Multiple matching pairs of inductive coils may be arranged in either concentric or other arrayed configurations.

As will be appreciated by one of ordinary skill, a plurality of inductive coils could provide both power as well as data transmission to/from the image capture and recording device affixed atop the mounting platform 18, or between the upper and lower portions, 14 and 12, or even to other peripheral devices, as desired.

In order to maintain an appropriate registration between the upper and lower portions, 14 and 12, during sliding (horizontally planar) movement of the upper portion 14 relative to the lower portion 12, rotation about the center location 30/32 should be maintained. Of course, any number of methods and mechanisms may be utilized to maintain the upper and lower portions, 14 and 12, in their proper registration during operation, without departing from the broader aspects of the present invention.

As drawing FIGS. 1 and 2 illustrate generally, by placing one of two resonant coils in each of the rotating halves/portions of the pan head 10, the transfer of power (and/or data) may be seamlessly accomplished without the use of mechanical couplings such as slip rings. Thus, the upper and lower portions, 14 and 12, may rotate relative to each other without the interference of cabling. As discussed previously, the type, form, positioning and number of the inductive coils may vary as necessary to affect a desired functionality.

While the inductive coils, 26 and 28, are envisioned as being near field inductive devices, the present invention is not limited in this regard, as the coils may alternatively be resonant inductive elements and assemblies, without departing from the broader aspects of the present invention.

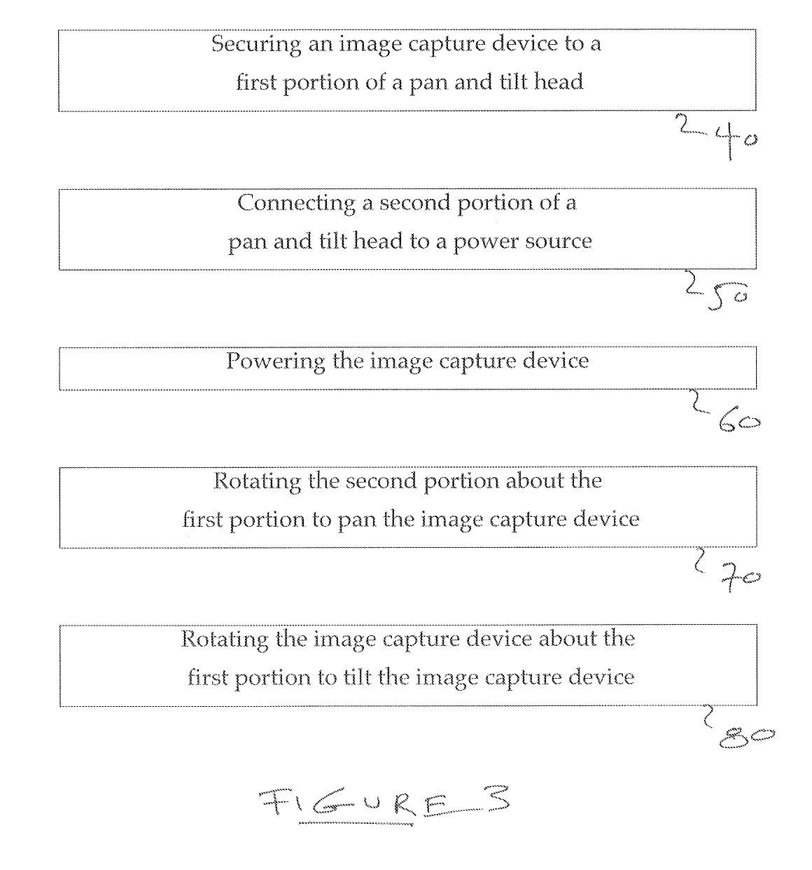

Referring now to FIG. 3, the present invention also contemplates a method of powering an image capture device. The method includes an initial step 40 of securing an image capture device, such as a camera, to a first portion of a pan and tilt head. The image capture device being rotatable relative to the first portion, to tilt the device, and in electrical communication with the first portion so that it may receive power.

The method includes a second step 50 of connecting a second portion of the pan and tilt head to a power source. The second portion is rotatably secured to the first portion and in electrical communication with the first portion via an inductive coupling device such as the above-described apparatus. The first portion may be rotated to pan the attached image capture device.

Additionally, the inventive method includes a step 60 in which the image capture device is powered through the power source.

As will be appreciated, the second portion may be rotated about the first portion to pan said image capture device (Step 70). Moreover, the image capture device may be rotated about the first portion to tilt the image capture device (Step 80).

While the invention has been described with reference to the preferred embodiments, it will be understood by those skilled in the art that various obvious changes may be made, and equivalents may be substituted for elements thereof, without departing from the essential scope of the present invention. Therefore, it is intended that the invention not be limited to the particular embodiments disclosed, but that the invention includes all embodiments falling within the scope of the appended claims.

What is claimed is:

1. A pan and tilt control system for an image capture device, said system comprising:
a pan and tilt head, said head having an attachment mechanism for selective attachment of an image capture device;
an inductive coupling device in electrical communication with said pan and tilt head, said inductive coupling device being rotatably secured to said pan and tilt head;
wherein an image capture device attached to said pan and tilt head is in electrical communication with said inductive coupling device and may be rotated about a first axis in a substantially horizontal plane and about a second axis in a substantially vertical plane.

2. The pan and tilt control system of claim 1 further comprising:
an image capture device removably secured to said pan and tilt head.

3. The pan and tilt control system of claim 1 further comprising:
a support structure operatively secured to said inductive coupling device.

4. The pan and tilt control system of claim 3 wherein said support structure is a tripod.

5. The pan and tilt control system of claim 2 further comprising:
a power source in electrical communication with said inductive coupling device; and
wherein said power source is in electrical communication with said image capture device.

6. The pan and tilt control system of claim 5 wherein said power source is a battery.

7. The pan and tilt control system of claim 5 wherein said inductive coupling device comprises:
a lower inductive coil portion operatively connected to said power source;
an upper inductive coil portion in electrical communication with said lower inductive coil portion, said upper portion being rotatable relative to said lower inductive coil portion about said first axis; and
wherein said pan and tilt head is rotatably secured to said upper inductive coil portion such that it may rotate about said second axis.

8. An inductive coupling device, said device comprising:
a lower inductive coil portion operatively connected to a power source;
an upper inductive coil portion in electrical communication with said lower inductive coil portion, said upper portion being rotatable relative to said lower inductive coil portion about a first axis;
an attachment mechanism secured to said upper inductive coil portion, said attachment mechanism being adapted for the attachment of an electronic device to said inductive coupling device; and
wherein said upper inductive coil portion may be rotated about said first axis to change an orientation of an attached electronic device.

9. The inductive coupling device of claim 8, wherein said attachment mechanism is rotatably secured to said upper inductive coil portion so that it may rotate about a second axis, said second axis having an angular orientation different from said first axis; and
wherein said attachment mechanism can be rotated about said second axis to change an orientation of an attached electronic device.

10. The inductive coupling device of claim 9, wherein said device further comprises:
a control arm operatively attached to said attachment mechanism; and
wherein said control arm may be selectively manipulated to rotate said attachment mechanism about said first and said second axes.

11. The inductive coupling device of claim 8 wherein said attachment mechanism includes a threaded engagement member for selective attachment of an electronic device.

12. The inductive coupling device of claim 9, wherein rotation about said first axis is in a substantially horizontal plane and rotation about said second axis is in a substantially vertical plane.

13. The inductive coupling device of claim 8, wherein said device includes a plurality of upper induction coil portions and a plurality of lower induction coil portions, said upper and lower induction coil portions being in electrical communication with one another.

14. The inductive coupling device of claim 8, wherein said electronic device is an image capture apparatus.

15. The inductive coupling device of claim 8, wherein said power source is a battery.

16. A method of powering an image capture device on a pan and tilt control head, said method comprising the steps of:
securing an image capture device to a first portion of a pan and tilt head, said image capture device being rotatable relative to said first portion and in electrical communication with said first portion;
connecting a second portion of said pan and tilt head to a power source, said second portion being rotatably secured to said first portion and in electrical communication with said first portion; and
powering said image capture device through said power source.

17. The method of claim 16 wherein said first portion of said pan and tilt head includes at least one induction coil.

18. The method of claim 17 wherein said second portion of said pan and tilt head includes at least one induction coil in electrical communication with said at least one induction coil of said first portion.

19. The method of claim 16 further comprising the step of:
rotating said second portion about said first portion to pan said image capture device.

20. The method of claim 16 further comprising the step of:
rotating said image capture device about said first portion to tilt said image capture device.
